(19) United States
(12) Patent Application Publication
(10) Pub. No.: US 2026/0346071 A1
(43) Pub. Date: Nov. 5, 2026

(54) FIRE DETECTION CONSOLIDATOR

(71) Applicant: Kidde-Fenwal, LLC, Ashland, MA (US)

(72) Inventor: Thomas Kjellman, Uxbridge, MA (US)

(73) Assignee: Kidde-Fenwal, LLC, Ashland, MA (US)

(21) Appl. No.: 19/742,211

(22) Filed: Jul. 15, 2026

Related U.S. Application Data
(63) Continuation of application No. 18/175,673, filed on Feb. 28, 2023, now Pat. No. 12,702,884.
(60) Provisional application No. 63/320,845, filed on Mar. 17, 2022.

(51) Int. Cl. A62C 37/48; A62C 3/00; A62C 37/42; A62C 99/00

(52) U.S. Cl. CPC A62C 37/48; A62C 37/42; A62C 99/009; A62C 3/006

(57) ABSTRACT

An actuation mechanism for a fire suppression system includes a first input, a second input, and an output. The first input features a first support and a first tension member, and the second input features a second support and a second tension member. The output includes an output tension member coupled to a retaining member. The retaining member has first and second engagement surfaces contoured to match complementary corresponding engagement surfaces of the first and second supports. In an inactive configuration, physical contact between the complementary engagement surfaces of the supports and the engagement surfaces of the retaining member blocks translation of the retaining member. In an active configuration, at least one of the first and second supports is spaced apart from the retaining member to allow translation of the retaining member.

### CROSS-REFERENCE TO RELATED APPLICATIONS

This application is a continuation of U.S. application Ser. No. 18/175,673, filed Feb. 28, 2023, which claims the benefit of U.S. Application No. 63/320,845, filed Mar. 17, 2022, the contents of which are incorporated by reference herein in their entireties.

### BACKGROUND

Embodiments of the present disclosure relate to a system and method for delivering a fire suppression agent to a cooking appliance in the event of a fire, and more particularly to an actuation mechanism operable to initiate delivery of a fire suppression agent through an agent delivery path.

Fire suppression systems typically include a plurality of detection lines such as link cables. It is sometimes desired for multiple detection lines associated with either the same region or different regions of the fire suppression system to be capable of initiating a central bank of canisters to release fire suppression agent. This control is typically provided by including duplicate input mechanisms to allow for a plurality of input lines. However, adapting the control box of the fire suppression system for use with multiple inputs increases the costs for all users, regardless of whether a system having multiple inputs is utilized.

### BRIEF DESCRIPTION

According to an embodiment, an actuation mechanism of a fire suppression system includes a first input having a first tension, a second input having a second tension, and an output. When the actuation mechanism is in an inactive configuration, the first input and the second input cooperate to maintain a third tension in the output.

In addition to one or more of the features described herein, or as an alternative, in further embodiments the first tension and the second tension are applied in a first direction and the third tension is applied in a second, opposite direction.

In addition to one or more of the features described herein, or as an alternative, in further embodiments the first tension and the second tension are applied in a first direction and the third tension is applied in the same first direction.

In addition to one or more of the features described herein, or as an alternative, in further embodiments both the first tension and the second tension are acting in a first direction.

In addition to one or more of the features described herein, or as an alternative, in further embodiments the first input further comprises a first support and a first tension member and the second input further comprises a second support and a second tension member.

In addition to one or more of the features described herein, or as an alternative, in further embodiments the first support and the second support are pivotally mounted.

In addition to one or more of the features described herein, or as an alternative, in further embodiments a first rotational axis of the first support is parallel to and coplanar with a second rotational axis of the second support.

In addition to one or more of the features described herein, or as an alternative, in further embodiments the output further comprises an output tension member and a retaining member connected to the output tension member.

In addition to one or more of the features described herein, or as an alternative, in further embodiments when the actuation mechanism is in the inactive configuration, the retaining member is arranged in contact with a portion of the first support and the second support.

In addition to one or more of the features described herein, or as an alternative, in further embodiments in the inactive configuration, a clearance is formed between the first support and the second support, wherein the clearance is smaller than the retaining member.

In addition to one or more of the features described herein, or as an alternative, in further embodiments each of the first support and the second support has an active end and when the actuation mechanism is in the inactive configuration, the retaining member is operably coupled to the active end of at least one of the first support and the second support.

In addition to one or more of the features described herein, or as an alternative, in further embodiments a surface of the active end of at least one of the first support and the second support is complementary to a corresponding surface of the retaining member.

In addition to one or more of the features described herein, or as an alternative, in further embodiments the fire suppression system further comprises a plurality of spray nozzles and the first input is associated with a first region of the plurality of spray nozzles and the second input is associated with a second region of the plurality of spray nozzles.

In addition to one or more of the features described herein, or as an alternative, in further embodiments the fire suppression system further comprises a plurality of spray nozzles and the first input is associated with a first region of the plurality of spray nozzles and the second input is associated with the first region of the plurality of spray nozzles.

In addition to one or more of the features described herein, or as an alternative, in further embodiments the fire suppression system further comprises a sensor and a manual activation system, wherein the first input is operably coupled to the sensor and the second input is operably coupled to the manual activation system.

In addition to one or more of the features described herein, or as an alternative, in further embodiments the actuation mechanism includes a plurality of stages including a first stage and a second stage, the first input, the second input, and the output being arranged within the first stage, wherein the output is operably to an input of the second stage.

Also disclosed is a method of operating an actuation mechanism of a fire suppression system includes providing a first input, a second input, and an output. The first input and the second input cooperate to restrict movement of the output. The method further including removing tension from the first input and removing tension from the output.

In addition to one or more of the features described herein, or as an alternative, in further embodiments comprising moving the first input out of a path of movement of the output in response to removing tension from the first input.

In addition to one or more of the features described herein, or as an alternative, in further embodiments the first input further comprises a first tension member and a first support and moving the first input out of the path of movement of the output further comprises rotating the first support about an axis.

In addition to one or more of the features described herein, or as an alternative, in further embodiments the first input is associated with a first region of the fire suppression system and the second input is associated with a second region of the fire suppression system. The method further includes activating a canister associated with the first region of the fire suppression system in response to removing tension from the output.

### BRIEF DESCRIPTION OF THE DRAWINGS

The following descriptions should not be considered limiting in any way. With reference to the accompanying drawings, like elements are numbered alike:

FIG. 1 is a schematic diagram of an exemplary system for delivering a fire suppression agent to at least one cooking appliance according to an embodiment;

FIG. 2 is a schematic diagram of an exemplary actuation mechanism in an inactive configuration according to an embodiment;

FIG. 3 is a schematic diagram of the actuation mechanism of FIG. 2 in an active configuration according to an embodiment;

FIG. 4 is a schematic diagram of an exemplary actuation mechanism in an inactive configuration according to an embodiment;

FIG. 5 is a schematic diagram of the actuation mechanism of FIG. 4 in an active configuration according to an embodiment;

FIG. 6 is a schematic diagram of an exemplary actuation mechanism in an inactive configuration according to an embodiment;

FIG. 7 is a schematic diagram of an exemplary actuation mechanism in an inactive configuration according to an embodiment;

FIG. 8 is a schematic diagram of the actuation mechanism of FIG. 7 in an active configuration according to an embodiment;

FIG. 9 is a schematic diagram of an exemplary actuation mechanism in an inactive configuration according to an embodiment.

### DETAILED DESCRIPTION

A detailed description of one or more embodiments of the disclosed apparatus and method are presented herein by way of exemplification and not limitation with reference to the Figures.

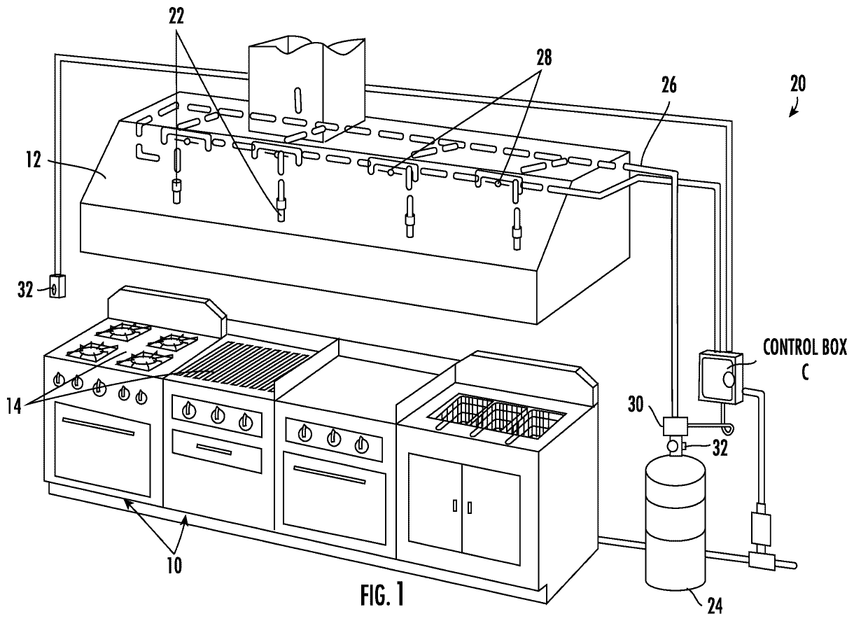

With reference now to FIG. 1, an example of a system 20 for delivering a fire suppression agent to one or more cooking appliances 10 is illustrated. The fire suppression system 20 may be located separate or remotely from the cooking appliance 10, such as within a vent hood 12, or alternatively, may be integrated or housed at least partially within a portion of the cooking appliance 10. It should be understood that the configuration of the fire suppression system 20 may vary based on the overall structural design of the cooking appliance 10. The fire suppression system 20 includes one or more spray nozzles 22 associated with the cooking appliance 10 and a source of fire suppression agent 24 in the form of at least one self-contained pressurized canister. In embodiments including a plurality of cooking appliances 10, one or more spray nozzles 22 may be dedicated to each cooking appliance 10, or alternatively, one or more evenly spaced spray nozzles 22 may be used for all of the cooking appliances 10.

The source of fire suppression agent 24 is arranged in fluid communication with the nozzles 22 via an agent delivery path defined by a delivery piping system 26. In the event of a fire, the fire suppression agent is allowed to flow through the delivery piping system 26 to the one or more spray nozzles 22 for release directly onto an adjacent cooking hazard area 14 of the one or more cooking appliances 10.

Those skilled in the art will readily appreciate that the fire suppression agent can be selected from materials such as water, dry chemical agent, wet chemical agent, or the like. Further, the source of fire suppression agent 24 may additionally contain a gas propellant for facilitating the movement of the fire suppression agent through the delivery piping system 26. However, embodiments where the propellant is stored separately from the fire suppression agent are also contemplated herein.

In an embodiment, the fire suppression system 20 is actuated in response to a fire sensing device (illustrated schematically at 28), such as a smoke detector or a heat sensor, for example. In response to heat or smoke exceeding an allowable limit, a control box C will direct a signal to an actuator 30 to open a valve 32 to allow the fire suppression agent to flow from the source 24 to the nozzles 22. For example, in an embodiment the fire sensing device is a heat sensor including an activator bulb. When a fire is present, the increased heat resulting from the flames will cause the activator bulb to break, thereby releasing the tension on the cable connecting the fire sensing device to the control box C. Alternatively, or in addition, the fire suppression system 20 may include a manual activation system 34, also referred to herein as a manual pull station, configured to actuate the control box C to activate the valve 32 to initiate operation of the fire suppression system 20.

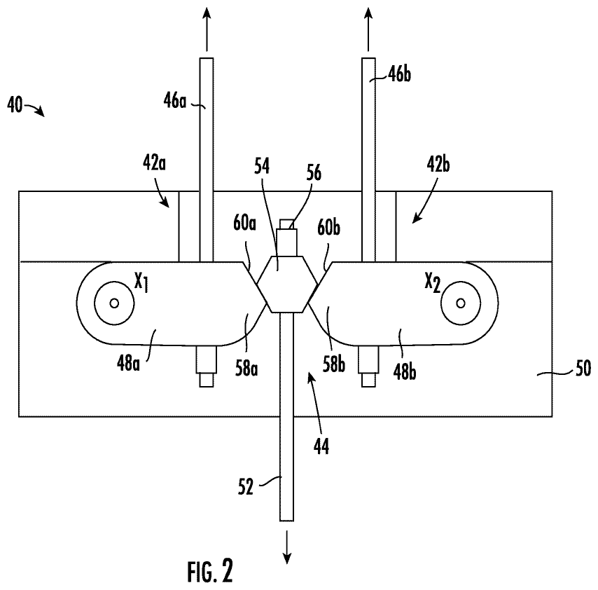

With reference now to FIGS. 2-5, exemplary embodiments of an actuation mechanism 40 are illustrated. In an embodiment, the actuation mechanism 40 may be arranged upstream from the control box C within the fire suppression system 20. However, embodiments where the actuation mechanism 40 is arranged at another location within the fire suppression system 20, or embodiments where the actuation mechanism 40 is adapted for use as the control box C are also contemplated herein. As shown, the actuation mechanism 40 includes a plurality of inputs and at least one output. In the illustrated, non-limiting embodiment, the plurality of inputs includes a first input 42a and a second input 42b, and the at least one output includes a single output 44. However, it should be understood that embodiments having more than two inputs, and two or more outputs are also within the scope of the disclosure.

The first input 42a may be associated with a first region of the fire suppression system 20 including a first plurality of spray nozzles 22 and the second input 42b may be associated with a second region of the fire suppression system 20 including a second plurality of spray nozzles 22. The first region and the corresponding first spray nozzles are distinct and may be located remotely from the second region and the corresponding second spray nozzles. However, embodiments where the first input 42a and the second input 42b are operably coupled to the same region of the fire suppression system 20 are also contemplated herein. In such embodiments, the first and second inputs 42a, 42b can provide redundancy within the fire suppression system 20.

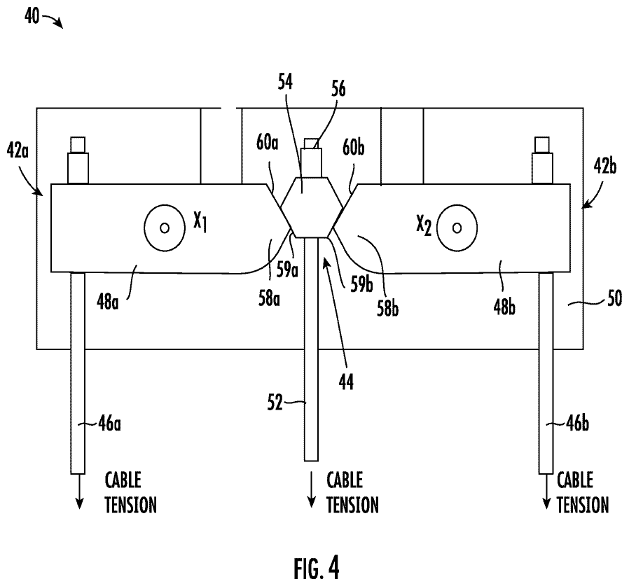

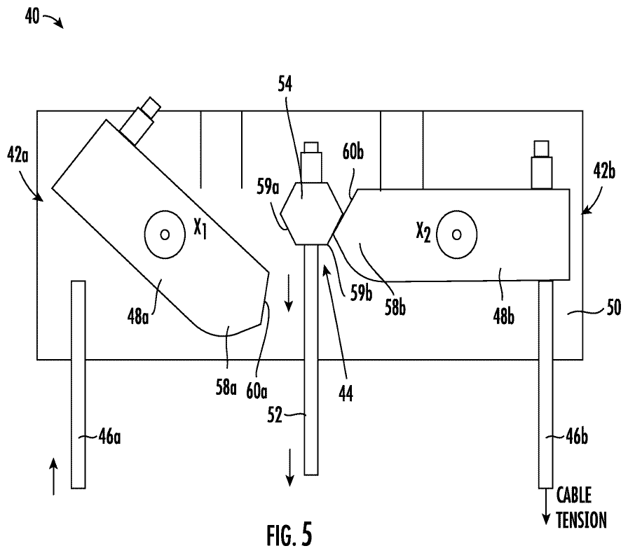

Each of the first input 42a and the second input 42b includes a respective tension member 46a, 46b, such as a rope or cable for example, and a support 48a, 48b operably coupled to the tension member 46a, 46b. Each tension member 46a, 46b may be coupled to or attached to a support 48a, 48b in any suitable manner. Although the tension members 46a, 46b are illustrated as being connected to an interior facing end of the supports 48a, 48b, respectively, embodiments where the tension members 46a, 46b are connected near to the supports 48a, 48b near an outward facing end thereof, as shown in FIGS. 4 and 5 for example, are also contemplated herein. Further, each of the first tension member 46a and the second tension member 46b may be operably coupled to a detector/sensor or a manual activation system 34. Accordingly, a first tension is typically applied to the first tension member 46a and a second tension is typically applied to the second tension member 46b.

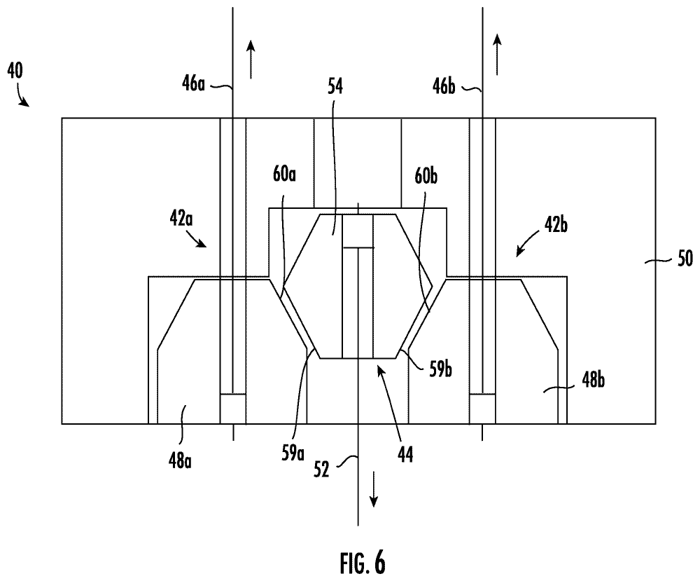

The first support 48a and the second support 48b may be substantially identical in size and shape. However, embodiments where the first and second supports 48a, 48b have different configurations are also contemplated herein. In the illustrated, non-limiting embodiment of FIGS. 2-5, the first support 48a and the second support 48b are pivotally mounted to a wall 50. In an embodiment, the wall 50 is a portion of the housing of the actuation mechanism 40. In other embodiments, as shown in FIGS. 6-8, at least one of the first support 48a and the second support 48b may be translatable relative to the wall 50. Further, in such embodiments, translation of the supports 48a, 48b in the direction of tension may be restricted. For example, the configuration of the wall 50 may be selected to define an end position along the path of movement of the support members 48a, 48b.

In an embodiment, tension is applied to each of the tension members 46a, 46b, of the first and second inputs 42a, 42b in the same first direction. As shown, the first support 48a and the second support 48b may be generally mounted in axial alignment. Alternatively, or in addition, the first rotational axis X₁ of the first support 48a and the second rotational axis [symbol] of the second support 48b may be oriented parallel to one another and coplanar.

The at least one output 44 includes a respective output tension member 52, such as a rope or cable for example, and a retaining member 54 connected to the output tension member 52, such as near at or near a first end 56 thereof. A second end of the output tension member 52 may be operably coupled to a valve, such as valve 32 for example, arranged in fluid communication with one or more canisters 24 of agent operably coupled to a respective region of the fire suppression system 20.

As shown, the first support 48a and the second support 48b are separated from one another such that a clearance is arranged therebetween. In an embodiment, the clearance is defined between an active end 58a, 58b of both the first support 48a and the second support 48b, respectively.

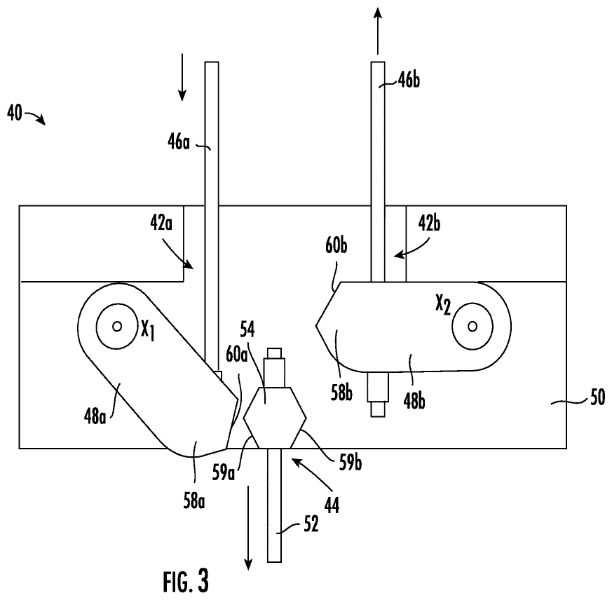

With continued reference to FIGS. 2-5, when the first and second tensions are applied to the first and second tension members 46a, 46b, respectively, as shown in FIGS. 2 and 4, the plurality of inputs 42a, 42b cooperate to maintain tension on the output 44 to oppose the gravitational force acting on the output 44. Accordingly, the first input 42a and the second input 42b cooperate to restrict movement of the output 44 in at least one direction, thereby maintaining the actuation mechanism 40 in an inactive configuration. Although the tensions applied to the tension members 46a, 46b are illustrated as being in a direction opposite the tension in the output tension member 52 in FIGS. 2 and 3, embodiments where the tensions are acting in the same direction, such as shown in FIGS. 4 and 5, are also contemplated herein. The retaining member 54 of the output 44 is arranged in contact with a portion of both the first support 48a and the second support 48b. For example, in the inactive configuration, the retaining member 54 is operably coupled and retained in the inactive position by the active ends 58a, 58b of the plurality of supports 48a, 48b. However, embodiments where the retaining member 54 is arranged in contact with another portion of one or more of the supports 48a, 48b, such as a top surface thereof for example, are also within the scope of the disclosure. Accordingly, the clearance defined between the supports 48a, 48b is greater than the output tension member 52, but is smaller than the retaining member 54.

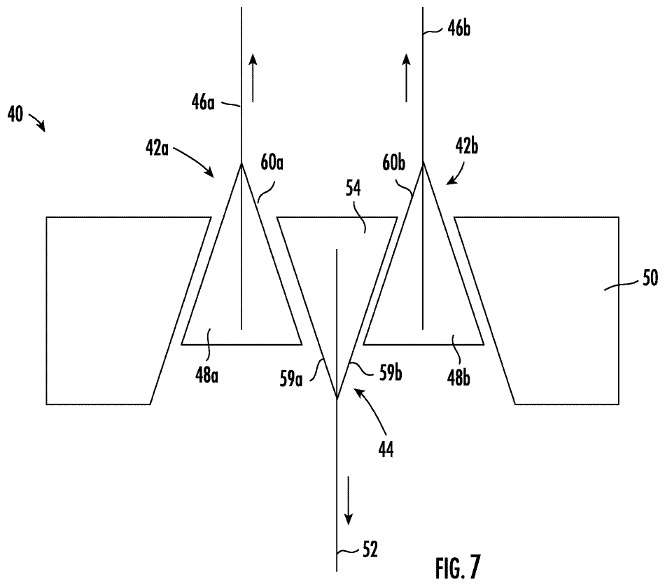

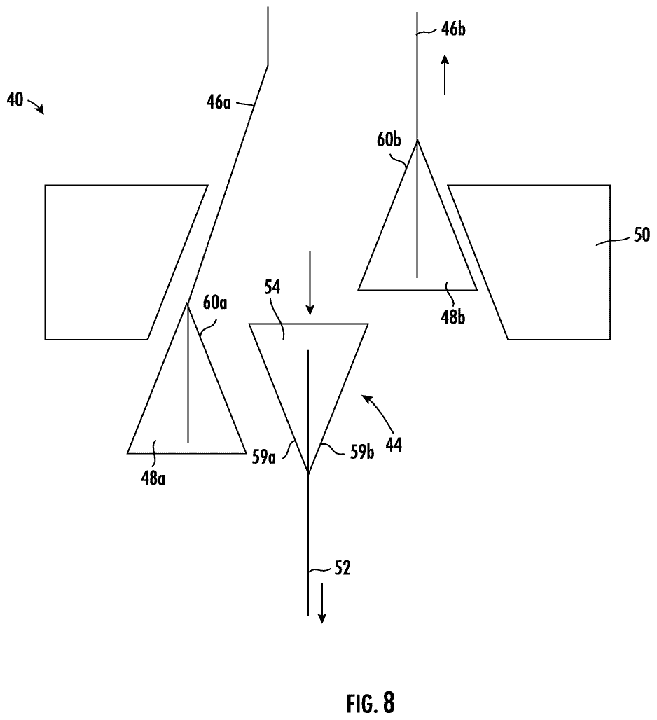

In the illustrated, non-limiting embodiment, a contour of at least one surface 59a, 59b of the retaining member 54 is selected to cooperate with and engage a corresponding surface 60a, 60b of the active end 58a, 58b of each of the first and second supports 48a, 48b. As shown, the retaining member 54 has a plurality of angled or sloped sides, and a surface 60a, 60b of the active ends 58a, 58b has a corresponding or complementary slope or angle. In the embodiment of FIGS. 2-5, the sloped surface are arranged only at the active end 58a, 58b of the supports. However, in other embodiments, such as shown in FIG. 6, other surfaces of the supports 48a, 48b may also have a sloped or angled surface. Although a retaining member 54 having a hexagonal configuration is pictured, it should be understood that a retaining member 54 having any suitable configuration, such as a partially curved retaining member for example is also within the scope of the disclosure. For example, with reference to FIGS. 7-8, each of the supports 48a and 48b and the retaining member 54 has a similar triangular configuration and the orientation of the retaining member 54 is opposite to the orientation of the supports 48a, 48b.

The actuation mechanism 40 may be transformable from an inactive configuration to an active configuration in response to a loss of tension of at least one of the plurality of inputs 42a, 42b. With reference now to FIGS. 3 and 5, the tension acting on the first tension member 46a has been removed, or applied in an opposite direction. Such a loss or change in tension may occur in response to detection of smoke of a heat exceeding an allowable threshold, or in response to operation of a manual activation system 34. As a result of this loss or change of tension, the first support 48a is no longer operable to cooperate with the second support 48b to oppose the force acting on the output tension member 52 and maintain the position of the retaining member 54.

In the illustrated, non-limiting embodiments of FIGS. 2-5, the force acting on the active end 58a of the first support 48a applied thereto by the retaining member 54 will facilitate rotation of the first support 48a about its axis X1, away from the second support 48b. In embodiments where tension is still acting on the tension member 46b of the second input 42b, the second support 48b will remain stationary. As the first support 48a rotates out of the path of movement of the output 44, the active end 58a disengages from the retaining member 54 thereby allowing the retaining member 54 to separate from the active end 58b of the second support 48b. Although the actuation mechanism 40 is illustrated and described in a vertical configuration where the supports 48a, 48b cooperate to oppose gravity acting on the retaining member 54, it should be understood that embodiments where the actuation mechanism 40 has another configuration and the supports 48a,48b cooperate to maintain a tension in the tension member 52 are contemplated herein.

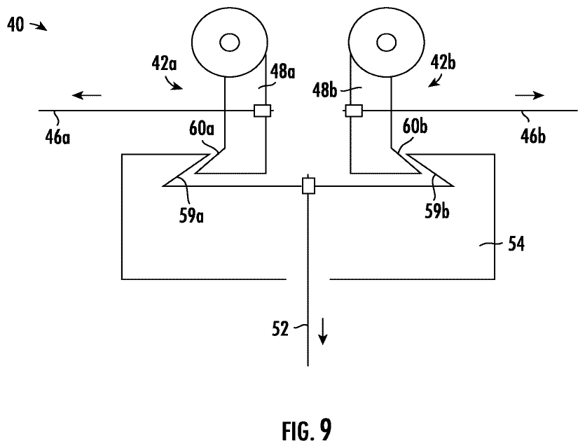

With reference now to FIG. 9 an actuation mechanism 40 according to another embodiment is illustrated. As shown, the retaining member 54 has a groove formed therein, and the active end 58a, 58b of each of the support members 48a, 48b is positioned within the groove. In the illustrated, non-limiting embodiment, a configuration of the active ends 58a, 58b is selected to engage a corresponding surface 59a, 59b of the retaining member 54 and restrict movement of the retaining member relative to the inputs 42a, 42b. Similar to the embodiments previously described, in response to a loss of tension acting on the tension member 46a of one of the inputs 42a, the first support 48a will move, for example rotate, out of engagement with the surface 59a of the retaining member 54. As a result, the tension acting on the retaining member 54 is sufficient to move the retaining member 54 relative to the second input 42b.

Although an actuation mechanism having a single stage of inputs and outputs is illustrated, it should be understood that embodiments having a plurality of stages (i.e. a first stage, a second stage, etc.) arranged in series, such as where the output of a first or upstream stage is operably coupled to the input of a second or downstream stage for example, are also contemplated herein.

The actuation mechanism 40 illustrated and described herein allows a plurality of detection cables to be consolidated at or prior to the control box C. In such embodiments, the control box C would require only a single input mechanism thereby providing a common assembly suitable for all applications. Further, in applications where all downstream items or components of a system are cable operated, an actuation mechanism as described herein may eliminate the need for a control box C all together.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. An actuation mechanism of a fire suppression system comprising:
a first input having a first support defining a first engage and a first tension member coupled to the first support;
a second input having a second support and a second tension member coupled to the second support; and
an output having an output tension member and a retaining member coupled to the output tension member, the retaining member including (i) a first engagement surface having contour matching a complementary corresponding engagement surface of the first support, and (ii) a second engagement surface having a contour matching a complementary corresponding engagement surface of the second support,
wherein the actuation mechanism has an inactive configuration and an active configuration, wherein in the inactive configuration the complementary corresponding engagement surface of the first support is in physical contact with the first engagement surface of the retaining member and the complementary corresponding engagement surface of the second support is in physical contact with the second engagement surface of the retaining member to block translation of the retaining member, and in the active configuration at least one of the first support and the second support is spaced apart from the retaining member.

2. The actuation mechanism of claim 1, wherein the first engagement surface and the second engagement surface of the retaining member are sloped surfaces, and the complementary corresponding engagement surfaces of the first support and the second support are complementary sloped surfaces.

3. The actuation mechanism of claim 2, wherein the sloped surfaces of the retaining member and the complementary sloped surfaces of the first support and the second support are inclined at an angle relative to a longitudinal axis of the output tension member.

4. The actuation mechanism of claim 1, wherein the fire suppression system further includes a source of fire suppression agent and a plurality of spray nozzles in fluid communication with the source.

5. The actuation mechanism of claim 1, wherein the first tension member, the second tension member, and the output tension member are mechanical cables.

6. The actuation mechanism of claim 1, wherein the fire suppression system further comprises a plurality of spray nozzles and the first input is associated with a first region of the plurality of spray nozzles and the second input is associated with a second region of the plurality of spray nozzles.

7. An actuation mechanism of a fire suppression system comprising:
a first input having a first support and a first tension member;
a second input having a second support and a second tension member; and
an output having an output tension member and a retaining member connected to the output tension member, the retaining member positioned between the first support and the second support;
wherein the first support and the second support are translatably mounted relative to a wall to permit linear translation along a translation path; and
wherein the actuation mechanism has an inactive configuration and an active configuration, wherein in the inactive configuration the first support and the second support are positioned adjacent to one another to define a gap that is narrower than a width of the retaining member, and in the active configuration at least one of the first support and the second support is linearly translated along the translation path to expand the gap to a width that is wider than the width of the retaining member.

8. The actuation mechanism of claim 7, wherein the housing wall includes a stop member that defines an end position of the translation path for the first support and the second support.

9. The actuation mechanism of claim 7, wherein the retaining member includes a first sloped engagement surface and a second sloped engagement surface, the first support includes a first complementary sloped engagement surface matching the first sloped engagement surface, and the second support includes a second complementary sloped engagement surface matching the second sloped engagement surface.

10. The actuation mechanism of claim 9, wherein the first and second sloped engagement surfaces of the retaining member and the first and second complementary sloped engagement surfaces of the first support and the second support are inclined at an angle relative to a longitudinal axis of the output tension member.

11. The actuation mechanism of claim 7, wherein in the inactive configuration, the gap is wider than a diameter of the output tension member.

12. The actuation mechanism of claim 7, wherein the first tension member and the second tension member extend parallel to one another, and are positioned in a same plane as the output tension member.

13. An actuation mechanism of a fire suppression system comprising:
a first input having a first support and a first tension member;
a second input having a second support and a second tension member; and
an output having an output tension member and a retaining member connected to the output tension member, the retaining member including a main body defining an internal groove,
wherein an active end of the first support and an active end of the second support are nested within the internal groove to lock the retaining member in a fixed position relative to the first input and the second input when the actuation mechanism is in an inactive configuration, and
wherein the actuation mechanism has an active configuration in which the first support is pivoted away from the retaining member and the active end of the first support is positioned outside of the internal groove.

14. The actuation mechanism of claim 13, wherein the first tension member and the second tension member extend in a direction perpendicular to a longitudinal axis of the output tension member.

15. The actuation mechanism of claim 14, wherein the first tension member and the second tension member extend horizontally in opposite directions, and the output tension member extends vertically downward.

16. The actuation mechanism of claim 13, wherein the first support and the second support are pivotally mounted to a housing to rotate about a respective pivot pin.

17. The actuation mechanism of claim 13, wherein the active end of the first support and the active end of the second support each have a hook-shaped profile nested within the internal groove of the retaining member.

18. The actuation mechanism of claim 13, wherein the fire suppression system further includes a plurality of spray nozzles, wherein the first input is associated with a first subset of the plurality of spray nozzles and the second input is associated with a second subset of the plurality of spray nozzles.

19. The actuation mechanism of claim 13, wherein the fire suppression system further includes a smoke detector and a manual pull station, wherein the first tension member is coupled to the smoke detector and the second tension member is coupled to the manual pull station.

20. The actuation mechanism of claim 13, wherein the main body of the retaining member completely surrounds the active end of the first support and the active end of the second support when the actuation mechanism is in the inactive configuration.
